(19) United States
(12) Patent Application Publication
(10) Pub. No.: US 2007/0167339 A1
(43) Pub. Date: Jul. 19, 2007

(54) Production of particles

(75) Inventors: Richard Arthur Birch, Kent (GB); Femi Durosinmi-Etti, Kent (GB)

Correspondence Address: MORGAN LEWIS & BOCKIUS LLP, 1111 PENNSYLVANIA AVENUE NW, WASHINGTON, DC, 20004, US

(73) Assignee: QUEST INTERNATIONAL SERVICES B.V., Naarden (NL)

(21) Appl. No.: 10/583,269

(22) PCT Filed: Dec. 14, 2004
(86) PCT No.: PCT/GB04/05244

§ 371 Date: Jun. 16, 2006

(30) Foreign Application Priority Data
Dec. 19, 2003 (GB) 0329439.4

(51) Int. Cl. C11D 17/00

(52) U.S. Cl. 510/191; 510/447; 510/446; 510/515

(57) ABSTRACT

A process is disclosed for the production of particles comprising at least one core of core material containing perfume absorbed therein, the core being coated with at least one water-soluble encapsulating material that is impervious to the said perfume, wherein the process comprises: mixing at least one water-soluble encapsulating material, an aqueous solution, at least one core material and at least one perfume to produce a slurry thereof; heating the slurry to reduce the water content thereof, so as to produce a molten or rubbery mass from the slurry, wherein heating is effected at least in part in a pre-heater (122); extruding the molten or rubbery mass through a die (24); and physically processing the extruded material to produce particles.

### FIELD OF INVENTION

The present invention relates to the production of particles containing a perfume absorbed therein. The particles find use in inclusion in dry products or articles.

### BACKGROUND TO THE INVENTION

Scented dry products such as dry laundry powders and other dry laundry products are more aesthetically pleasing to the consumer, and may impart a pleasant fragrance to fabrics. However, the amount of perfume carryover from an aqueous laundry bath onto fabrics is often marginal. The detergent manufacturing industry, therefore, has long searched for an effective perfume delivery system for use in laundry products to provide long-lasting, storage-stable fragrance to the product, as well as fragrance to the laundered fabrics.

Laundry and other fabric care compositions that contain perfume mixed with or sprayed onto the compositions are well known in the art and currently commercialized. Because perfumes are made of a combination of volatile compounds, perfume can be continuously emitted from simple solutions and dry mixes to which the perfume has been added. Various techniques have been developed to hinder or delay the release of perfume from compositions so that they will remain aesthetically pleasing for a longer time.

One such technique is described in International patent application WO02/09663 (Quest International B.V.). This discloses a particle suitable for inclusion in a dry product or article, the particle comprising a core of swellable material containing perfume absorbed therein, the core being coated with at least one water-soluble encapsulating material which prevents evaporation or dissipation of the loaded perfume from the particles to the atmosphere or their surroundings, e.g. laundry product base. Thus, the particles remain stable upon storage, with improved perfume retention. Furthermore, when the particles are incorporated into a cleaning product of dry form, e.g. laundry powder or tablet, the particles may be stable to attack by other ingredients in the product base and are typically able to withstand conditions of high relative humidity. Additionally and conveniently, the particles retain substantial amounts of the absorbed perfume upon exposure to water and demonstrate excellent in-use perfume release characteristics from a laundry product during the soaking of fabric articles and/or following deposition of the particles on a fabric surface. Example 5 of WO00/09663 describes production of pellets using a Modula Co-Rotating Twin Screw System extruder (Model TSE 24HC, Prism Ltd, Lichfield, UK), which is a laboratory scale extruder having an internal diameter of 24 mm.

### SUMMARY OF INVENTION

The present invention provides a process for the production of particles comprising at least one core of core material containing perfume absorbed therein, the core being coated with at least one water-soluble encapsulating material that is impervious to the said perfume, the process comprising:
a) mixing at least one water-soluble encapsulating material, an aqueous solution, at least one core material and at least one perfume to produce a slurry thereof;
b) heating the slurry to reduce the water content thereof, so as to produce a molten or rubbery mass from the slurry, wherein heating is effected at least in part in a pre-heater;
c) extruding the molten or rubbery mass through a die; and
d) physically processing the extruded material to produce particles.

The process of the invention results in production of particles in the form of a matrix encapsulate or agglomerate, with each particle comprising a matrix of encapsulating material typically containing a plurality of cores of core material loaded with perfume.

The invention also includes within its scope particles produced by the process of the invention.

The particles find application by inclusion in dry products and articles, e.g. selected from laundry products, such as granular laundry powders and laundry tablets, laundry detergents, other fabric cleaning or softening products, autodishwash powders, autdishwash tablets, sheet conditioners, rim blocks, soaps and powder and granular cleaning compositions.

The invention thus also encompasses a dry product or article containing a particle in accordance with the invention.

The particles of the present invention are substantially impervious to the absorbed perfume by virtue of the encapsulating material which coats a core of core material, preventing evaporation or dissipation of the loaded perfume from the particles to the atmosphere or their surroundings, e.g. laundry product base. Thus, advantageously, when the particles of the present invention are incorporated in a dry product or article, the particles remain stable upon storage with improved perfume retention. Furthermore, when the particles are incorporated into a cleaning product of dry form, e.g. laundry powder or tablet, the particles may be stable to attack by other ingredients in the product base and are typically able to withstand conditions of high relative humidity. Additionally and conveniently, particles in accordance with the invention retain substantial amounts of the absorbed perfume upon exposure to water and demonstrate excellent in-use perfume release characteristics from a laundry product during the soaking of fabric articles and/or following deposition of the particles on a fabric surface.

The core material is preferable swellable material. The term “swellable” as used herein means a material that expands and increases in volume when in contact with a perfume, as the perfume is absorbed into the material. As a result, a core of swellable material becomes swollen on absorption of perfume.

The swellable material is typically, and preferably, non-porous and is conveniently an organic polymer. Suitable organic polymers are discussed in more detail below. The term “non-porous” as used herein means a material that does not contain pores and/or cavities.

Organic polymer core materials, such as are preferably used in the process of the invention, tend to be delicate and prone to physical damage when subjected to physical processing steps, particularly those involving shear forces. It is preferred that such materials are not exposed to shear forces greater than about 2,000 s⁻¹. Such damage is undesirable as it can result in increased perfume loss during processing, resulting in production of particles containing less perfume than desired. Also shear damage to the core particles can result in several particles agglomerating together so that they do not disperse in the laundry wash and are visible as particles on fabric after washing. Particular care must thus be taken when processing such core materials. This is discussed further below.

The term “rubbery mass” as used herein means a material that is at a temperature between its glass transition temperature (Tg) and its melting point (Tm). At such a temperature it is in a state where it flows with high viscosity (i.e. it is in a rubbery state). Below its Tg the material will not flow. Above its Tm there is a phase change in which the material becomes a flowing liquid.

For effective extrusion of the molten or rubbery mass through the die and subsequent processing to form particles, it has been found important for the temperature of the mass to be at a suitable value. The temperature must be above the Tg of the material so that it flows, as noted above. However, the temperature is desirably close to the Tg so that the material flows through the die and then forms a solid shortly thereafter. If the temperature is too low, the back pressure on the die is excessively high. If the temperature is too high, the extruded material is sticky and tends to aggregate, which hinders the formation of particles. In particular it is preferred that the temperature on extrusion is not more than about 25° C., more preferably not more than about 15° C., above the Tg of the encapsulating material. At a suitable temperature after extrusion, the encapsulating material can flow over and cover any exposed core material.

It is general necessary for the slurry to be initially processed at a higher temperature than that appropriate for extrusion, so that temperature has to be reduced during the course of the process. Achieving suitable temperature control presents certain difficulties, particularly when using organic polymer core materials that are prone to damage. This aspect is discussed further below.

In particular, it is generally necessary for the slurry to have a higher water content, (e.g. 20% by weight) than that desired in the resulting end product particles, (e.g. <2.5% by weight), for the slurry to have a suitable viscosity for processing. As a result, it is necessary to reduce the water content of the slurry before extrusion, and this is achieved by heating. However, for effective extrusion through the dye, the temperature of the molten or rubbery mass should not be too high, as noted above. An important consideration in the invention, particularly when using organic polymer core materials that are prone to damage, is control of water content, viscosity and temperature of materials being processed.

The process of the invention is typically carried out using an extruder, with the material in the form of a slurry or rubbery mass being fed to the extruder (before, during or after heating) and the material being conveyed along the extruder to the die at the downstream end. Control of the temperature of material in the extruder is of importance, so that the material passing through the die is at an appropriate temperature, as noted above.

In embodiments using organic polymer core materials that are prone to damage, it is highly desirable to use an extruder designed to produce little or no shear. It is therefore appropriate to use an extruder having all conveying (forward or reverse) screw profiles and having no mixing paddles or kneading elements in the screw profile. This has the effect of preventing or reducing damage and degradation to the core material that would otherwise occur as a result of excessive shear during the extrusion process.

Where the process is carried out using a small diameter extruder (having an internal diameter of 45 mm or less) it has been found possible to achieve temperature control to heat the slurry sufficiently at the upstream end to remove sufficient water and yet to cool the molten or rubbery mass sufficiently by the time it reaches the dye at the downstream end, even when using a low shear extruder (having no mixing paddles or kneading elements) as discussed above. However, when using a larger diameter extruder (having an internal diameter of greater than 45 mm, preferably greater than 50 mm, more preferably greater than 60 mm), as is required for commercial production, such temperature control has not been found possible in a low shear extruder, thus presenting difficulties when processing mixtures including organic polymer core materials that are prone to damage. These difficulties have been overcome in accordance with the invention by use of a pre-heater to heat the slurry prior to delivery to the extruder. The pre-heater preferably comprises a low shear rising film packed plate heat exchanger.

The extruded material is physically processed to produce particles. Suitable processing techniques include chopping, cutting (preferably face-cutting), grinding and pulverising. The processing may be carried out as the material exits the dye, or after the material has cooled. The material is processed to produce particles of desired size.

One preferred technique involves cutting strands of extrudate emerging from the die to an appropriate length using a face cutter. The cut strands are then transferred to a cyclone, for cooling, classification and collection. Finished particles can thus be produced in a single process, without the need for milling and further coating.

Typically, the water-soluble encapsulating material is present in an amount in the range 20% wt to 60% wt, preferably an amount in the range 25% wt to 50% wt, based on the weight of the slurry

The aqueous solution is typically present in an amount in the range 10% wt. to 30% wt, preferably an amount in the range 10% wt to 25% wt, based on the weight of the slurry to produce a slurry of suitable viscosity to be handled by the process of the invention.

Typically, the core material is present in an amount in the range 5% wt. to 50% wt., preferably an amount in the range 10% wt. to 30% wt, more preferably in an amount in the range 15% wt to 25% wt, based on the weight of the slurry.

The perfume is preferably present in an amount in the range 10% wt to 60% wt, more preferably an amount in the range 15% wt to 45% wt, based on the weight of the slurry.

The slurry may optionally include further materials in appropriate amounts, such as optional colouring material present at an amount considered by those skilled in the art appropriately to provide the desired color in the final product.

The slurry is preferably combined and blended by any low-shear means, such as by tank mixing with variable-shear agitation.

Preferably, the combining and blending of the slurry occurs for at least one minute.

The slurry may be heated using any low-shear heating method suitable for non-Newtonian fluids.

The slurry is preferably heated to a temperature in the range 40° C. to 170° C. It is preferred to avoid higher temperatures, as they can result in increased perfume loss during processing, which is undesirable. The heating preferable reduces the water content to less than 15% wt, more preferably to less than 10% wt, to produce a material suitable for extrusion.

The temperature of the extruded material immediately after leaving the die is preferably not more than 25° C. above the glass transition temperature (Tg) of the encapsulating material to facilitate subsequent processing to produce particles. The material should be above the Tg of the encapsulating material as the material is otherwise too solid for extrusion.

During the extrusion process, the mixture is forced through a die having at least one orifice with a predetermined diameter, which typically is in the range from about 0.8 mm to 2.0 mm, preferably from 1.0 mm to 1.5 mm. However, much higher diameters for the die are also possible. The die is preferably designed so that the maximum rise in temperature of material passing therethrough is about 15° C. As noted above, the temperature of the product as it exits the die orifice is above, but preferably not more than 25° C. above, the glass transition temperature (Tg) of the water-soluble encapsulating material. The apparatus is preferably equipped with a cutter knife or any other cutting device allowing to chop the melt as it exits from the die when it is still plastic. The product which is cut is thus still at a temperature which is above its glass transition temperature. The extruded product is then allowed to cool, or is cooled by any conventional means (such as pneumatic conveying to a cyclone), to a temperature below its glass transition temperature.

Preferably, the extruder is maintained at a temperature of from about 70° C. to about 240° C., more preferably from about 80° C. to about 220° C., and most preferably from about 80° C. to about 160° C. In this way, adequate conveying and forming of the materials is ensured. The residence time of the slurry in the extruder is preferably from about 0.5 minutes to about 10 minutes, more preferably from about 1 minute to about 4 minutes, and most preferably from about 2 minutes to about 4 minutes.

The extruder can be any known extrusion apparatus, including but not limited to, extruders commercially available from APV Baker (CP Series), Werner & PFleiderer (Continuous and ZSK Series), Wenger (TF Series); Leistritz (ZSE Series), Buss (LR Series), Reiten Lausar (BT Series); Weber (DS Series), Columbo (RC Series), Buehler, Berstorff, and Thermoprism.

Extrusion of the particles of this invention may be carried out by any extrusion method such as is described, for example, in European patent specification EP-B-0 486 592 (Henkel KGBA) or International patent applications WO-A-93/02176 (Henkel KGaA) and WO-A-94/09111 (Henkel KGaA). In this extrusion process, a solid premix is extruded under pressure to form a strand and, after emerging from the multiple-bore extrusion die, the strands are cut into granules of predetermined size by means of a cutting unit.

In one preferred embodiment of the invention, the slurry is delivered, preferably continuously, to a planetary roll extruder or to a twin-screw extruder with co-rotating or contra-rotating screws, of which the barrel and the extrusion/granulation head can be heated to the predetermined extrusion temperature. Under the conveying effect of the extruder screws, the premix is extruded in the form of fine strands through the multiple-bore extrusion die in the extruder head and, finally, size-reduced by means of a cutter, for example rotating cutting blade, preferably in particles to the form of which is spherical, cylindrical or a shape between spherical and cylindrical. The bore diameter of the multiple-bore extrusion die and the length to which the strands are cut are adapted to the desired particle size. In this embodiment, particles are produced in a substantially uniformly predeterminable particle size, the absolute particle sizes being adaptable to the particular application envisaged.

Particles according to the present invention typically have an average particles size in the range from 10 micrometers to 2000 micrometers, preferably from 50 micrometers to 1500 micrometers, more preferably from 75 micrometers to 1000 micrometers and even more preferably from 100 micrometers to 750 micrometers, depending upon the type of product into which they are to be incorporated.

For example, if the particles are intended to be used in a laundry powder, it is especially preferred to use particles with an average size of at least 500 micrometers and desirably not larger than 1500 micrometers in order to prevent the particles segregating within the powder. However, particles having an average particle size of greater than 1500 micrometers could suitably be employed in tablets for laundry or autodishwash applications, where a single particle may comprise each tablet, delivering a single dose of perfume.

The resulting particles may be optionally dried or subjected to other downstream processing steps as appropriate.

The term “coated” as used herein means a layer of encapsulating material which is applied to a core such that the core is in intimate contact with the encapsulating material, being fully covered and enclosed within said encapsulating material.

The term “stable” as used herein means that the integrity of a particle remains unaffected upon exposure of the particle to typical conditions of 20° C./40% relative humidity, and preferably 37° C./70% relative humidity and/or exposure of the particle to hostile agents contained in dry products or articles such as enzymes and the like, so that there is no premature release of absorbed perfume by degradation of the coating.

The term “high relative humidity” as used herein means typically 20° C./40% relative humidity, and preferably 37° C./70% relative humidity.

The term “water-soluble” as used herein means a material or mixture of materials which dissolve(s) in water or aqueous solutions, possibly under a variety of conditions of temperature and pH, e.g. at neutral or alkaline pH, i.e. pH 7 to 12, possibly at 40° C., preferably at 30° C., and more preferably at 20° C.

The term “water-dispersible” as used herein means there is no visible residue on, for example, cloth after a wash and/or rinse cycle.

Swellable Materials

As noted above, it is preferred to use core material that is a swellable material, which is preferably non-porous, and which is suitably an organic polymer. Preferably, the organic polymer produced by polymerization results in a solid core, rather than a hollow capsule. Advantageously, formation of a solid core enables access to the desired size range of particles, and the polymerization reaction may be carried out in the absence of perfume.

Suitable organic polymers useful herein are polymers of a vinyl monomer that may be cross-linked or partially cross-linked. It is also possible to use simple linear polymers, however, these can give cores which may lack structural integrity so may dissolve when added to a perfume, or at least be somewhat sticky. Thus, it is usually convenient and preferred to introduce some cross-linking or chain branching.

Therefore, suitable organic polymers useful herein may be formed by polymerisation of vinyl monomers, with some cross-linking and/or chain branching agent included in the monomers that are polymerised, so that some cross-links are formed between the polymer chains. If a cross-linking agent is used, the proportion of cross-linking may be low, so that after polymerisation there may be some polymer chains that remain entirely linear and are not cross-linked to any other chains.

A number of vinyl monomers containing a single carbon-carbon double bond may be used. One suitable category of monomers (A) are esters of acrylic and alkyl acrylic acids of formula:
H₂C═C(R₁)CO₂R₂
where R.sub.1 is hydrogen or straight or branched alkyl of 1 to 6 carbon atoms, preferably 1 to 3 carbon atoms and R.sub.2 is straight or branched alkyl of 1 to 8 carbon atoms, preferably 3 to 6 and most preferably 3 or 4 carbon atoms in a straight or branched chain.

These monomers may be used either singly, or in the form of a combination of two or more monomers.

Specific examples of suitable monomers are isobutyl methacrylate (which is particularly preferred), n-butyl acrylate, n-butyl methacrylate, isobutyl acrylate, n-propyl acrylate and iso-propylmethacrylate. Less preferred is methyl methacrylate.

Another suitable monomer is styrene.

Cross-linking between polymer chains formed from the above monomers can be achieved by including in the monomer mixture a small proportion--for example less than 10%, preferably as little as 5% or 1%—of a monomer having at least two carbon-carbon double bonds. The use of such a material to provide cross-linking is well known in other applications of polymers, although it is usual to introduce a greater proportion of cross-linking than is required for this invention. Examples of this type of cross-linking agent are divinyl benzene, diesters formed between acrylic acid and diols, such as 1,4-butane diol diacrylate, and higher esters formed between acrylic acid and polyols—which may be sugars.

Chain branching can be introduced by including among the monomers a hydroxyalkyl monomer of formula:
H₂C═C(R₁)CO₂R₃
where R.sub.1 is as specified above and R.sub.3 is alkyl of 1 to 6 carbon atoms bearing at least one hydroxy group, preferably 3 to 4 carbon atoms in a straight or branched chain and bearing a single hydroxy group. These monomers undergo a side reaction during the course of polymerization, and this side reaction produces chain branching. When there is chain branching without cross-linking, it is suitable that a hydroxyalkyl monomer of the above formula provides from 10 to 40% by weight of the monomer mixture.

Suitable hydroxyalkyl monomers are hydroxypropyl methacrylate, hydroxybutylacrylate, and hydroxyethylacrylate.

A further suitable category of monomers (B) are esters of acrylic or methacrylic acids of formula:
H₂C═C(R₄)CO₂R₅
where R.sub.4 is hydrogen or methyl and R.sub.5 is a straight or branched alkyl of 9 to 16 carbon atoms.

These monomers may be used either singly, or in the form of a combination of two or more monomers.

Specific examples of suitable monomers of the aforementioned category include decyl(meth)acrylates, dodecyl(meth)acrylates, tetradecyl(meth)acrylates, and hexa-decyl(meth)acrylates.

The above-described monomers of category (B) may be combined with one or more further monomers that possess a polymerising unsaturated group, provided that the monomers of category (B) account for the main moiety and are present in not less than 50% by weight of the monomer mixture.

The further monomers which are effectively usable in combination with the monomers of category (B) include (meth)acrylates of monovalent aliphatic alcohols of not more than 9 carbon atoms such as methyl(meth)acrylates, ethyl(meth)acrylates, butyl(meth)acrylates, 2-ethylhexyl(meth)acrylates, and n-octyl(meth)acrylates; (meth)acrylates of monovalent aliphatic alcohols of not less than 17 carbon atoms such as octadecyl(meth)acrylates and behenyl(meth)acrylates; (meth)acrylates of alicyclic alcohols such as cyclo-hexyl(meth)acrylates and menthyl(meth)acrylates; (meth)acrylates of phenols such as phenyl(meth)acrylates and octylphenyl(meth)acrylates; aminoalkyl(meth)acrylates such as dimethylaminoethyl(meth)acrylates and diethylaminoethyl(meth)acrylates; (meth)acrylates possessing a polyoxyethylene chain such as polyethylene glycol mono(meth)acrylates and methoxypolyethylene glycol mono(meth)acrylates; (meth)acrylamides such as (meth)acrylamides, N-methylol(meth)acrylamides, and dimethylaminoethyl(meth)acrylamides; polyolefins such as ethylene and propylene; aromatic vinyl compounds such as styrene, .alpha.-methyl styrene, and t-butyl styrene; and vinyl chloride, vinyl acetate, acrylonitrile, and (meth)acrylic acids, for example. These monomers may be used either singly, or in the form of a combination of two or more monomers.

Cross-linking between polymer chains formed from the above-mentioned monomers can be achieved by including greater than 0.001% to less than 10% by weight of a cross-linkable monomer having at least two carbon-carbon double bonds which functions as a cross-linking agent.

Examples of suitable cross-linkable monomers for use with category (B) monomers include ethylene glycol di(meth)acrylates, diethylene glycol di(meth)acrylates, polyethylene glycol di(meth)acrylates, polyethylene glycol polypropylene glycol di(meth)acrylates, polypropylene glycol di(meth)acrylates, 1,3-butylene glycol di(meth) acrylates, N,N-propylene bis-acrylamide, diacrylamide dimethyl ether, N,N-methylene bis-acrylamide, glycerol di(meth)acrylates, neopentyl glycerol di(meth)acrylates, 1,6-hexane diol di(meth)acrylates, trimethylol propane tri(meth)acrylates, tetramethylol propane tetra(meth)acrylates, polyfunctional(meth)acrylates obtained by the esterification of alkylene oxide adducts of polyhydric alcohols (such as, for example, glycerine, neopentyl glycol, trimethylol propane, trimethylol ethane, and tetramethylol methane) with (meth)acrylic acids, and divinyl benzene, for example. These cross-linkable monomers may be used either singly, or in the form of a combination of two or more monomers.

The properties of the resulting cross-linked polymers obtained by reacting monomers of category (B) with a suitable cross-linkable monomer (or an optional further monomer as above described) and methods for their preparation, are described more fully in EP-B-441,512, incorporated herein by reference.

Optionally, a particle as described herein may additionally comprise at the exterior of the core, a further polymer that incorporates free hydroxyl groups, as described more completely in WO 98/28398, incorporated herein by reference. Advantageously, the attachment of the polymer incorporating free hydroxyl groups to the core is such that the polymer is not completely removed upon contact of the particle with water. Therefore, under the appropriate conditions, the water-soluble encapsulating material typically dissolves and the polymer incorporating free hydroxyl groups serves to enhance deposition onto (or retention on) skin or surfaces such as vitreous surfaces or fabric. Typically, the further polymer that incorporates free hydroxyl groups is selected from polyvinyl alcohol, cellulose, or chemically modified cellulose.

Organic polymers comprising a monomer from either category (A) or (B) may be prepared using the technique of suspension polymerisation. This is a process in which the organic monomers are formed into a suspension in an aqueous phase, and polymerised. It is customary to stabilise the suspension by incorporating a stabilising agent in the aqueous phase before adding one or more monomers. Suitable stabilising agents include polyvinyl alcohol, anionic surfactants, or non-ionic surfactants with HLB of at least 8. Alternatively, the organic polymers may be formed by emulsion polymerisation which technique produces cores of approximately <1 micrometer which can be agglomerated to a desired particle size. Polymerisation of each suspended droplet leads to a bead of polymer. These techniques are more fully described in WO 98/28398, herein incorporated by reference.

A further suitable technique for the preparation of organic polymers includes bulk or solvent polymerisation which technique produces blocks of polymers which may require grinding to particulate form.

If the particle comprises a further polymer with free hydroxyl groups, such as polyvinyl alcohol, at the exterior of a core, attachment of said further polymer can be achieved by polymerising the monomers in the presence of the polymer with free hydroxyl groups using the technique of suspension polymerisation as described in WO 98/28398.

Perfumes

As used herein the term “perfume” denotes a substantially water-insoluble composition of matter consisting of one or more perfume components, optionally mixed with a suitable solvent or diluent, which is used to impart a desired odor to the product to which it is added and/or to skin or fabric. Perfume components are those constituents of a perfume which are added thereto only or primarily for their olfactive contribution. The number of perfume components in a perfume is typically ten or more. In many instances, the molecular weight of a perfume component is in excess of 150, but does not exceed 300.

Perfume components may be natural products such as essential oils, absolutes, resinoids, resins, concretes, etc., and synthetic perfume components such as hydrocarbons, alcohols, aldehydes, ketones, ethers, acids, esters, acetals, ketals, nitrites, etc., including saturated and unsaturated aliphatic, carbocyclic and heterocyclic compounds.

The particles of the present invention typically comprise from 5% to 50% by weight of the particle of perfume, preferably from 10% to 40%, and more preferably from 15% to 30%.

Perfume components which may be used in the particles of the present invention include: acetyl cedrene, 4-acetoxy-3-pentyltetrahydropy- ran, 4-acetyl-6-t-butyl-1,1-dimethylinidane, available under the trade mark “CELESTOLIDE”, 5-acetyl-1,1,2,3,3,6-hexamethylindane, available under the trademark “PHANTOLIDE”, 6-acetyl-1-isopropyl-2,3,3,5-tetramethy-lindane, available under the trade mark “TRASEOLIDE”, alpha-n-amylcinnamic aldehyde, amyl salicylate, aubepine, aubepine nitrile, aurantion, 2-t-butylcyclohexyl acetate, 2-t-butylcyclohexanol, 3-(p-t-butylphenyl)propanal, 4-t-butylcyclohexyl acetate, 4-t-butyl-3,5-dinitro-2,6-dimethyl acetophenone, 4-t-butylcyclohexanol, benzoin siam resinoids, benzyl benzoate, benzyl acetate, benzyl propionate, benzyl salicylate, benzyl isoamyl ether, benzyl alcohol, bergamot oil, bornyl acetate, butyl salicylate, carvacrol, cedar atlas oil, cedryl methyl ether, cedryl acetate, cinnamic alcohol, cinnamyl propionate, cis-3-hexenol, cis-3-hexenyl salicylate, citronella oil, citronellol, citronellonitrile, citronellyl acetate, citronellyloxyacetaldehyde, cloveleaf oil, coumarin, 9-decen-1-ol, n-decanal, n-dodecanal, decanol, decyl acetate, diethyl phthalate, dihydromyrcenol, dihydromyrcenyl formate, dihydromyrcenyl acetate, dihydroterpinyl acetate, dimethylbenzyl carbinyl acetate, dimethylbenzylcarbinol, dimethylheptanol, dimethyloctanol, dimyrcetol, diphenyl oxide, ethyl naphthyl ether, ethyl vanillin, ethylene brassylate, eugenol, geraniol, geranium oil, geranonitrile, geranyl nitrile, geranyl acetate, 1,1,2,4,4,7-hexamethyl-6-acetyl-1,2,3,4-tetrahy-dronaphthalene, available under the trademark “TONALID”, 1,3,4,6,7,8-hexahydro-4,6,6,7,8,8-hexamethylcyclopenta-2-benzopyran, available under the trade mark “GALAXOLIDE”, 2-n-heptylcyclopentanone, 3a,4,5,6,7,7a-hexahydro-4,7-methano-1(3)H-inden-6-ylpropionate, available under the trade mark “FLOROCYCLENE”, 3a,4,5,6,7,7a-hexahydro-4,7-methano-1(3)H-inden-6-ylacetate, available under the trade mark “JASMACYCLENE”, 4-(4′-hydroxy-4′-methylpentyl)-3-cyclohexenecarbaldehyde, alpha-hexylcinammic aldehyde, heliotropin, HERCOLYN D, which is a trade mark of Hercules Inc. and is a mixture of dihydro and tetrahydro methyl abietate, hexyl aldone, hexyl cinnamic aldehyde, hexyl salicylate, hydroxycitronellal, i-nonyl formate, 3-isocamphylcyclohexanol, 4-isopropylcyclohexanol, 4-isopropylcyclohexyl methanol, indole, ionones, irones, isoamyl salicylate, isoborneol, isobornyl acetate, isobutyl salicylate, isobutylbenzoate, isobutylphenyl acetate, isoeugenol, isolongifolanone, isomethyl ionones, isononanol, isononyl acetate, isopulegol, lavandin oil, lemongrass oil, linalool, linalyl acetate, methyl beta orcinyl carboxylate (LRG 201), 1-menthol, 2-methyl-3-(p-isopropylphenyl)propanal, 2-methyl-3-(p-t-butylphenyl)propa-nal; 3-methyl-2-pentyl-cyclopentanone, 3-methyl-5-phenyl-pentanol, alpha and beta methyl naphthyl ketones, methyl ionones, methyl dihydrojasmonate, methyl naphthyl ether, methyl 4-propyl phenyl ether, Mousse de chene Yugo, myrtenol, neroli oil, nonanediol-1,3-diacetate, nonanol, nonanolide-1,4, nopol acetate, 1,2,3,4,5,6,7,8-octahydro-2,3,8,8-tetramethyl-2-acetyl-naphthalene, available under the trade mark “ISO-E-SUPER”, octanol, Oppoponax resinoid, orange oil, p-t-amylcyclohexanone, p-t-butylmethylhydrocinnamic aldehyde, 2-phenylethanol, 2-phenylethyl acetate, 2-phenylpropanol, 3-phenylpropanol, para-methan-7-ol, para-t-butylphenyl methyl ether, patchouli oil, pelargene, petitgrain oil, phenoxyethyl isobutyrate, phenylacetaldehyde diethyl acetal, phenylacetaldehyde dimethyl acetal, phenylethyl n-butyl ether, phenylethyl isoamyl ether, phenylethylphenyl acetate, pimento leaf oil, rose-d-oxide, Sandalone, styrallyl acetate, 3,3,5-trimethyl hexyl acetate, 3,5,5-trimethylcyclohexanol, terpineol, terpinyl acetate, tetrahydrogeraniol, tetrahydrolinalool, tetrahydromuguol, tetrahydromyrcenol, thyme oil, trichloromethylphenylcar-binyl acetate, tricyclodecenyl acetate, tricyclodecenyl propionate, 10-undecen-1-al, gamma undecalactone, 10-undecen-1-ol, undecanol, vanillin, vetiverol, vetiveryl acetate, vetyvert oil, acetate and propionate esters of alcohols in the list above, aromatic nitromusk fragrances, indane musk fragrances, isochroman musk fragrances, macrocyclic ketones, macrolactone musk fragrances, and tetralin musk fragrances.

Perfumes frequently include solvents or diluents, for example: ethanol, isopropanol, diethylene glycol monoethyl ether, dipropylene glycol, diethyl phthalate and triethyl citrate.

Perfumes which are used in this invention may, if desired, have deodorant properties as disclosed in U.S. Pat. No. 4,303,679, U.S. Pat. No. 4,663,068 and EP-A-545556.

If the cores are impregnated with a perfume after manufacture of the cores, but before processing in accordance with the invention, we have found that the absorption of perfume can be enhanced by choosing materials with a hydrophobic character, or by mixing a hydrophobic oil into the perfume.

Examples of hydrophobic oils which can enhance perfume uptake include dibutyl phthalate and alkane mixtures such as isoparaffin and di(C.sub.8-C.sub.10 alkyl) propylene glycol diesters.

When the cores of swellable material as described hereinabove are allowed to absorb a perfume, they can absorb a surprising quantity, typically at least their own weight of perfume and often in excess of their own weight.

Typically, the w/w ratio of core material to perfume is in the range 5:1. to 1:5, preferably in the range 3:1 to 1:5 and more preferably in the range 2:1 to 1:5.

Incorporation of Perfume in Swellable Material

The absorption of a perfume by a swellable material, can be brought about by simply bringing the perfume and the swellable material into contact, and allowing them to stand. This may be achieved by mixing a perfume with the swellable material after they have been separated from the aqueous phase, or it may be achieved by mixing perfume into an aqueous slurry of swellable material and allowing the mixture to equilibrate. It can also be achieved by mixing the swellable material and perfume separately into an aqueous liquid product and allowing that mixture to equilibrate.

Water-Soluble Encapsulating Materials

The term “water-soluble encapsulating material” as used herein is intended to cover one, or a mixture of materials. For brevity and simplicity, the water-soluble encapsulating material will be referred to as “the encapsulating material” or “the encapsulating materials” or “an encapsulating material”.

Typically, the encapsulating materials useful herein are capable of forming a uniform, cohesive coating around multiple swellable materials, thus conveniently enabling retention of the absorbed perfume within the particle. Furthermore, art encapsulating material dissolves upon contact of the particles with water or aqueous solutions at neutral or alkaline pH as it is not chemically bonded to a core. The encapsulating material is also suitably stable under conditions of high relative humidity (being substantially non-hygroscopic). Additionally, or alternatively, the encapsulating material may be stable to attack by hostile ingredients in a dry product or article.

Preferably, the encapsulating material suitable for use herein forms a glassy i.e. non crystalline coating. The glass is formed by heating the material to above the glass transition temperature, Tg, of the material. Alternatively, in order to facilitate processing, the material may be heated to above its melting temperature, Tm.

The water-soluble encapsulating materials useful herein are generally selected from hydroxylic compounds, proteins, and synthetic film-forming polymers, or mixtures thereof. Preferably, the water-soluble encapsulating materials are hydroxylic compounds or synthetic film-forming polymers, and mixtures thereof.

Suitable hydroxylic compounds for use herein are typically selected from one or more of carbohydrates, or derivatives thereof, and natural or synthetic gums, or mixtures thereof. Preferably, the hydroxylic compound is a carbohydrate, or derivative thereof.

Suitable carbohydrates, or derivatives thereof for use herein can be any or a mixture of a: i) sugar where in the context of the invention the term “sugar” is intended to cover monosaccharides, disaccharides, oligosaccharides, polysaccharides and polyols and derivatives thereof and references to “sugar” should be construed accordingly; ii) starches including modified starches and hydrolysates; and iii) hydrogenates of i) and ii), e.g. maltodextrin.

Both linear and branched carbohydrate chains may be used. In addition chemically modified starches may be used. Typical modifications include the addition of hydrophobic moieties of the form of alkyl or aryl groups etc., identical to those found in surfactants to impart some surface activity to these compounds. Preferred carbohydrates, or derivatives thereof for use herein are sugars, starches or modified starches, and mixtures thereof, possibly admixed with hydrogenates of sugars and starches e.g. maltodextrin available for example under the trade name “Glucidex 21” from Roquette Freres, Lestrem, France.

Suitable sugars for use herein include sucrose, maltose, mannitol, maltitol and anhydrous isomalt, or mixtures thereof.

A preferred sugar is maltose, available for example as a maltose syrup under the trade name “Flolys D5780” from Roquettes Freres (which has a Tg of 87° C.-Rooos, Y. 1993, Carbohydr. Res. 238: 39-48) or as a high maltose syrup under the trade name “Flolys D5777S” which also contains other mono, oligo and polysaccharides and is also commercially available from Roquette Freres, Lestrem, France. Good results have been obtained using Flolys 5780 maltose.

Suitable starches or modified starches include Capsul E.TM., N-LOK.TM. and Hi-Cap.TM., all of which are commercially available from National Starch Chemical Co., Bridgewater, USA.

Examples of suitable natural or synthetic gums for use herein include alginic acid and salts and derivatives thereof, carrageenan, xanthan gum, carboxymethyl cellulose salts, gum arabic, gum tragacanth and gum karaya.

Proteins suitable for the purposes of the present invention include for example, gelatin and casein, and derivatives thereof.

Also suitable for use herein are synthetic film-forming polymers where in the context of the invention, by the term “film-forming” is meant a polymer which is capable of forming a coherent coating. Generally, synthetic film-forming polymers having a carboxylic acid moiety are insoluble at acidic pH but are typically water-soluble under the in-use conditions of a cleaning product, i.e. at alkaline pH. Examples of suitable synthetic film-forming polymers include polyacrylic acid based polymers, such as for example the Glascol.TM. series commercially available from Ciba Speciality Chemicals, Bradford, UK, which are polymer latices of polyacrylic acid; polymethacrylic acid based polymers such as the Eudragit.TM. series commercially available from Rohm & Haas, Philadelphia, USA; polyacrylonitrile; and polyvinyl alcohol commercially available for example as Gohsenol GH-23.TM. from Nippon Gohsei, Osaka, Japan, with polyvinyl alcohols having a high amount of hydrolysis being preferred.

Glass transition temperature, commonly abbreviated “Tg”, is a well known and readily determined property for glassy materials. This transition is described as being equivalent to the liquidification, upon heating through the Tg region, of a material in the glassy state to one in the liquid state. It is not a phase transition such as melting, vaporisation, or sublimation. [See William P. Brennan, “What is a Tg?” A review of the scanning calorimetry of the glass transition”, Thermal Analysis Application Study #7, Perkin-Elmer Corporation, March 1973.] Measurement of Tg is readily obtained by using a Differential Scanning Calorimeter.

For the purposes of the present invention, the Tg of a water-soluble encapsulating material is obtained for the anhydrous material not containing any plasticizer (which will impact the measured Tg value of the water-soluble encapsulating material). Glass transition temperature is also described in detail in P. Peyser, “Glass Transition Temperatures of Polymers”, Polymer Handbook, Third Edition, J. Brandrup and E. H. Immergut (Wiley-Interscience; 1989), pp. VI/209-VI/277.

At least one of the water-soluble encapsulating materials useful in the particles of the present invention preferably has an anhydrous, nonplasticized Tg. of at least 0° C., preferably at, least about 20° C., more preferably at least about 40° C., even more preferably at least 60° C., and most preferably at least about 100° C. It is also preferred that, these materials be low temperature processable, preferably within the range of from about 50° C. to about 200° C., and more preferably within the range of from about 60° C. to about 180° C. Such water-soluble encapsulating materials include hydroxylic compounds such as sucrose, maltose, starch hydrolysates such as corn syrups and maltodextrin, and hydrogenated starch hydrolysates.

The encapsulating material may include optional additive ingredients such as plasticizers, anti-agglomeration agents, pigments, dyes, preservatives, optical brighteners, pearlescent agents, salts, dispersion aids, conditioning agents and mixtures thereof.

Examples of suitable optional plasticizers include sorbitol, water, polyethylene glycol, propylene glycol, low molecular weight carbohydrates, and the like, with sorbitol, polyethylene glycol, low molecular weight polyols or water, and mixtures thereof, being preferred. Most preferred is water. Whilst not wishing to be bound by theory, it is believed that the presence of a small amount of a plasticizer in the encapsulating material helps to prevent excessive brittleness and thus cracking of the glassy coating formed around a core. The plasticizer is generally employed at levels of from about 0.01% to about 25% by weight of the encapsulating material.

Typically, if water is employed as a plasticizer in the encapsulating material, then the encapsulating material generally comprises greater than 0%, preferably greater than 0.5%, and generally less than 10%, preferably less than 7% and more preferably less than 5% by weight of the particle of water.

The optional anti-agglomeration agents according to the present invention are preferably inert powders or dusts, including Elemental Group II stearates and tri-calcium diphosphate, and are typically included at low levels of less than 5% by weight of the encapsulating material.

The invention will now be described in further detail, by way of illustration, in the following examples and with reference to the accompanying drawings, in which

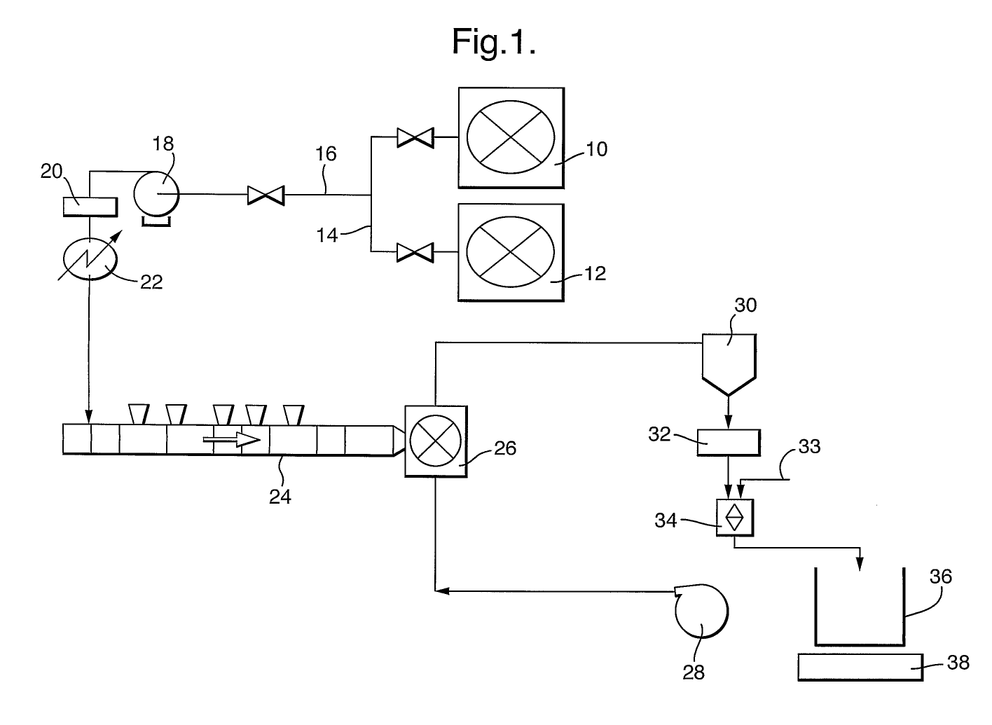

FIG. 1 is a flow diagram illustrating the process of one embodiment in accordance with the invention.

Referring to FIG. 1, the illustrated apparatus comprises two integrated bulk containers (IBCs) 10 and 12 to which are supplied the slurry-forming ingredients of encapsulating material, aqueous solution, core material and perfume. The ingredients are stirred continually within the IBCs with a lower shear stirrer, to pre-mix the ingredients in a way that will not damage delicate polymer core materials. The mixing is sufficient to shear thin the slury and reduce its viscosity so it is easy to pump, with viscosity typically being reduced from around 25,000 mPas to around 14,000 mPas. The slurry is maintained at ambient temperature, and typically has a water content of about 20% wt.

The two IBCs 10 and 12 are connected via a manifold 14 to a common flow line 16, with appropriate valves being provided to ensure a constant supply of slurry.

Slurry is pumped in line 16 by means of a pump 18 (LabuBrox Baureihe 2) through a flow meter 20 (Proline Promag 53, Endress & Hauser) to a pre-heater 22.

Pre-heater 22 is a low shear rising film packed plate heat exchanger, and consists of a Patelec boiler, B8/V2 and three plate heat exchangers, two M3 and one M6. The typical set point for the pre-heater is 120° C. to 135° C., e.g. 126° C. The shear experienced in the pre-heater is <50 s⁻¹. The pre-heater acts to raise the temperature of the slurry in a low-shear manner, so that the water content of the slurry is reduced from about 20% weight to about 7% weight.

From the pre-heater 22, the slurry (which is homogeneous) passes directly by gravity to extruder 24 (Berstorff Z60A-HT). This is a twin co-rotating screw extruder, having a barrel internal diameter of 64 mm, suitable for commercial production at rates of over 100 kg/hr. The extruder has nine barrels, each 5 diameters (5 D) in length, i.e. the total length of the extruder is 45 D. Barrels 3, 4, 5 and 6 have openings to the atmosphere to allow steam to escape. Barrel 7 has an opening which can be open to atmosphere or connected to vacuum. The barrels are set at appropriate temperatures to heat the slurry being conveyed through the extruder to remove further water, so that slurry at the downstream end contains about 2% wt water.

The extruder is a low shear extruder that has all conveying (forward or reverse) screw profiles and that has no mixing paddles or kneading elements in the screw profile. All of the screws are forward conveying elements, apart from a single reverse screw element just before the vent of barrel 7. This has the effect of preventing or reducing damage and degradation to delicate core material that might otherwise occur during the extrusion process.

The exit of the extruder, at the downstream end, is provided with a die plate having a number of holes, typically each 1 mm in diameter. The slurry is forced through the die, which is designed so that the maximum rise in temperature of material passing therethrough is about 15° C.

A face cutter 26 (BCTG, Buehler) is provided adjacent the extruder die plate, and cuts strands of exudate emerging from the die to appropriate length, typically 1 mm.

The extruder is operated so the temperature of the exudate is slightly above the Tg of the encapsulating material (less than 25° C. above, and preferably less than 15° C. above) so that the particles are not too tacky and do not tend to agglomerate. However, the encapsulating material can nevertheless flow over and cover any core material exposed during extrusion and cutting.

The particles are blown by the action of a blower 28 and transferred pneumatically to a cyclone 30 where they are collected and then classified in a classifier 32 (Gough screen). During the transfer and within the cyclone, the particles cool to near ambient temperature. Further, the particles tend to be rounded as they cool in the transfer to the cyclone. Finished particles are thus produced in one process, without the need for milling and further coating.

Flow aid is added via line 33 to the particles in a tumble mixer 34, and the particles collected and stored in a bulk bag 36 located over a load cell 38.

### EXAMPLE 1

Particles were prepared from the following materials.

| Ingredient | % wt. |
|---|---|
| Polymer¹ | 20 |
| Perfume² | 20 |
| Maltose³ | 40 |
| Water | 20 |
| Pigment⁴ | 0.1 |

¹Polyisobutylmethacrylate cross linked with 0.05% 1,4-butane diol diacrylate (BDDA) using 88% hydrolysed polyvinyl alcohol (Gohsenol GH-23 ™ available from Nippon Gohsei, Osaka, Japan) as the suspension stabilizer, as in WO98/28398. The material has an average particle size of 100 microns. (This is the core material).
²Perfume CT0057, available from Quest International, Ashford, England.
³Flolys D5780, available from Roquette, Lestrem, France. The Tg of this material is 87° C. (This is the coating material).
⁴Vibracolor Green PGR7-L, available from Ciba, Macclesfield, England. (This is colouring material).

Using the apparatus of FIG. 1, the polymer, perfume and maltose were mixed in the water in the IBCs to prepare a feed slurry. The feed slurry was pumped at 43 kg/hour through the pre-heater at a setting of 128° C. The mixture passed directly to the extruder (Berstorff Model ZE60A-HT).

The screw speed was 50 rpm The barrel temperatures were set at the following temperatures to optimise the reduction of water content:

| | | |
|---|---|---|
| Barrel | 1 | ambient |
| | 2 | 160° C. |
| | 3 | 160° C. |
| | 4 | 160° C. |
| | 5 | 150° C. |
| | 6 | 110° C. |
| | 7 | 90° C. |
| | 8 | 80° C. |
| | 9 | 80° C. |

Barrel 7 was open to the atmosphere.

Additional water-cooling was applied to barrels 8 and 9 to achieve the desired temperature.

The dried slurry in the form of a molten or rubbery mass was extruded at 100° C., (i.e. 13° C. above the Tg of maltose) through a die with 126 holes, each 1.0 mm in diameter, and cut into short lengths with the rotating face cutter with 6 blades operating at 1150 rpm.

Once cooled and collected from the cyclone, magnesium stearate (1%) was added to the beads as flow aid.

The final product contained 24.5% perfume and 1.5% water and was water dispersible. The resulting particles had sizes in the range 0.5 to 1.5 mm.

### EXAMPLE 2

A feed slurry was prepared as described in Example 1, and was processed in the apparatus of FIG. 1.

The feed slurry was pumped at 90 kg/hour through the pre-heater at a setting of 126° C. The mixture passed directly to the extruder.

The screw speed was 100 rpm. The barrel temperatures were set as in Example 1.

A moderate vacuum (approx −0.5 Bar) was applied at barrel 7.

Additional water-cooling was applied to barrels 8 and 9 to achieve the desired temperature.

The dried slurry was extruded through a die with 252 holes, each 1.0 mm in diameter at 100° C. and cut into short lengths with the rotating face cutter with 6 blades operating at 2457 rpm.

Once cooled and collected from a cyclone, magnesium stearate (1%) was added to the beads as flow aid.

The final product contained 23.4% perfume and 2.0% water and was water dispersible. The resulting particles had sizes in the range 0.5 to 1.5 mm.

### EXAMPLE 3

This is an example of extruded product being too hot to cut effectively, because the die temperature could not be maintained close to the Tg of the water-soluble encapsulated material.

A feed slurry was prepared as described in Example 1, and processed in a modified version of the apparatus of FIG. 1, not including a pre-heater and using a different extruder.

The feed slurry was pumped at 80 kg/hour directly to the extruder (Berstorff Model ZE60, 65 mm diameter). No pre-heater was used. The extruder was operated with the following conditions:

Nine barrels, barrels 1, 2, 5, 6, and 8 each 4 L/D, barrels 3, 4, 7 and 9 each 6 L/D. Barrels 4, and 5 with atmospheric vents, barrels 7 and 8 with atmospheric or vacuum vent. Twin co-rotating screws, all conveying elements, except for reverse screw elements just before each atmospheric vent, three reverse elements just before vacuum vent 7 and two reverse elements just before vacuum vent 8. The screw speed was 230 rpm The barrel temperatures were set at the following temperatures to optimise the reduction of water content:

| | | |
|---|---|---|
| Barrel | 1 | ambient |
| | 2 | 200° C. |
| | 3 | 220° C. |
| | 4 | 220° C. |
| | 5 | 180° C. |
| | 6 | 180° C. |
| | 7 | 150° C. |
| | 8 | 80° C. |
| | 9 | 80° C. |

A vacuum was applied at barrel 7 (−0.5 Bar) and barrel 8 (−0.7 Bar).

The dried slurry was extruded through a die with 313 holes, each 1.0 mm in diameter at a temperature of 128° C., i.e. more than 25° C. above the Tg of maltose. It was not possible to cut the material into short lengths and prevent them from aggregating as the temperature of the product was too high and it was too soft and sticky. The final product contained 21.8% perfume and 1.5% water. The product had a lower perfume content because of the higher barrel temperature adopted.

### EXAMPLE 4

This is an example of non-dispersible beads produced with high shear screw elements.

A feed slurry was prepared as in Example 1 and processed in a modified version of the apparatus of FIG. 1, not including a pre-heater and using a different extruder.

The feed slurry was pumped at 20 kg/hour directly to the extruder (Buehler Model DNDL, 44 mm diameter). No pre-heater was used. The extruder was operated with the following conditions. Ten barrels, each 4 L/D. Barrels 4, 6 and 8 with atmospheric vents. Twin co-rotating screws, high shear mixing elements in barrels 1 to 3, and plugs before the vents at barrels 4, 6 and 8. The screw speed was 400 rpm The barrel temperatures were set at the following temperatures to optimize the reduction of water content: Barrel 1 ambient, barrels 2 to 6, 150° C., barrels 7 to 10, 25° C.

The dried slurry was extruded through a die with 90 holes, each 1.0 mm in diameter at a temperature of 101° C. and cut into short lengths with a rotating face cutter with 2 blades operating at 3175 rpm.

The final product contained 18.8% perfume and 2.0% water. The beads were not water dispersible. The product had a lower perfume content due to damage to the polymer cores caused by the mixing elements in the extruder. The resulting particles had sizes in the range 0.5 to 1.0 mm.

### EXAMPLE 5

Particles in accordance with the invention may be employed with good effect in a laundry powder as indicated below.

The following laundry powder (all amounts in % by weight) was prepared by standard (non-tower) mixing techniques:

| | |
|---|---|
| Sodium tripolyphosphate | 40.0 |
| Sodium silicate | 6.20 |
| Sodium sulphate | 36.85 |
| SDBS* | 9.00 |
| C₁₂₋₁₅ alcohol (7EO) ethoxylate | 4.30 |
| CMC**, enzymes, fluorescer | 3.00 |
| Particles of example 1 | 0.30 |

*Sodium dodecyl benzene sulphonate
**Sodium carboxymethyl cellulose

Fabrics washed with this laundry powder in the normal household wash cycle had a pleasing perfume odour 4 days after being dried.

### EXAMPLE 6

Modified particles were prepared as in Example 1, with the maltose replaced by:

| | |
|---|---|
| Maltose | 20% wt |
| Sucrose | 20% wt |

### EXAMPLE 7

Modified particles were prepared as in Example 1, with the maltose replaced by:

| | |
|---|---|
| Sucrose | 40% wt |

### EXAMPLE 8

Modified particles were prepared as in Example 1, with the maltose replaced by:

| | |
|---|---|
| Maltose | 20% wt |
| Maltodextrin DE21 | 20% wt |

### EXAMPLE 9

Modified particles were prepared as in Example 1, with the maltose replaced by:

| | |
|---|---|
| Sucrose | 20% wt |
| Maltodextrin DE21 | 20% wt |

1. A process for the production of particles comprising at least one core of core material containing perfume absorbed therein, the core being coated with at least one water-soluble encapsulating material that is impervious to the said perfume, the process comprising:
a) mixing at least one water-soluble encapsulating material, an aqueous solution, at least one core material and at least one perfume to produce a slurry thereof;
b) heating the slurry to reduce the water content thereof, so as to produce a molten or rubbery mass from the slurry, wherein heating is effected at least in part in a pre-heater;
c) extruding the molten or rubbery mass through a die; and
d) physically processing the extruded material to produce particles.

2. A process according to claim 1, wherein the temperature of the slurry on extrusion is not more than about 25° C., more preferably not more than about 15° C., above the Tg of the encapsulating material.

3. A process according to claim 1, wherein the core material comprises a swellable material.

4. A process according to claim 3, where the core material comprises organic polymer.

5. A process according to claim 1, wherein the pre-heater comprises a low shear rising film packed plate heat exchanger.

6. A process according to claim 1, wherein extrusion is carried out using an extruder having an internal diameter greater than about 45 mm, preferably greater than about 50 mm, more preferably greater than about 60 mm.

7. A process according to claim 1, wherein extrusion is carried out using an extruder having all conveying screw profiles and having no mixing pedals or kneading elements in the screw profile.

8. A process according to claim 1, wherein the water-soluble encapsulating material is present in an amount in the range 20% weight to 60% weight, preferably an amount in the range 25% weight to 50% weight, based on the weight of the slurry.

9. A process according to claim 1, wherein the aqueous solution is present in an amount in the range 10% weight to 30% weight, preferably an amount in the range 10% weight to 25% weight, based on the weight of the slurry.

10. A process according to claim 1, where core material is present in an amount in the range 5% weight to 50% weight preferably in an amount in the range 10% weight to 30% weight, more preferably an amount in the range 15% to 25% weight, based on the weight of the slurry.

11. A process according to claim 1, wherein perfume is present in an amount 10% weight to 60% weight, more preferably an amount in the range 15% to 45% weight, based on the weight of the slurry.

12. A process according to claim 1, wherein the slurry includes colouring material.

13. A process according to claim 1, wherein the extruded material is processed by a technique selected from chopping, cutting, preferably face-cutting, grinding and pulverising to produce particles.

14. A process according to claim 1, wherein the slurry is heated to a temperature in the range 40° C. to 170° C.

15. A process according to claim 1, wherein heating of the slurry reduces the water content to less than 15% weight, more preferably less than 10% weight of slurry.

16. A process according to claim 1, wherein the extruder is maintained at a temperature in the range 70° C. to 240° C., preferably 80° C. to 220° C., more preferably 80° C. to 160° C.

17. A particle produced by the process of claim 1.

18. A dry product or article containing a particle according to claim 17.

19. A product or article according to claim 18, selected from laundry product, autodishwash powders, autodishwash tablets, sheet conditions, rim blocks, soap and powder and granular cleaning compositions.
